(19) United States
(12) Patent Application Publication
(10) Pub. No.: US 2025/0055957 A1
(43) Pub. Date: Feb. 13, 2025

(54) CONVERSATION BASED GUIDED INSTRUCTIONS DURING A VIDEO CONFERENCE

(71) Applicant: International Business Machines Corporation, Armonk, NY (US)

(72) Inventors: Anuradha Ramamoorthy, Cary, NC (US); Diane Chalmers, Rochester, MN (US); Fabio de Oliveira Franco, Toronto (CA)

(21) Appl. No.: 18/366,159

(22) Filed: Aug. 7, 2023

(51) Int. Cl. H04N 7/15; G06F 3/04815; G06V 40/16; G10L 15/08; G10L 15/26

(52) U.S. Cl. CPC H04N 7/152; G06F 3/04815; G06V 40/174; G10L 15/08; G10L 15/26; H04N 7/155

(57) ABSTRACT

Computer-implemented methods for conversation based guided instructions during a video conference are provided. Aspects include determining a first participant in the video conference requires assistance completing a task on an application and determining a second participant in the video conference is providing an instruction on how to complete the task. Aspects also include obtaining the instruction provided by the second participant and displaying a visual representation of the instruction on a display of the first participant.

### BACKGROUND

The present disclosure generally relates to video conferencing systems, and more specifically, to methods and systems for methods for providing conversation based guided instructions during a video conference.

Recently, the use of video conferencing software to conduct meeting has drastically increased and many individuals who are unfamiliar with video conferencing software are beginning to use video conferencing software to conduct meetings that were previously conducted in person. In addition, the number of different video conferencing software systems has increased.

During a video conference meeting, a participant of the video conference needs to perform a task on the device being used to conduct the video conference, such as a tablet or computer system. When the participant is unsure of how to complete the task, the participant often asks other participants on the video conference for guidance on completing the task. As a result, significant time of the video conference is used to try to teach the participant how to perform the task.

### SUMMARY

Embodiments of the present disclosure are directed to computer-implemented methods for providing conversation based guided instructions during a video conference. According to an aspect, a computer-implemented method includes determining a first participant in the video conference requires assistance completing a task on an application and determining a second participant in the video conference is providing an instruction on how to complete the task. The method also includes obtaining the instruction provided by the second participant and displaying a visual representation of the instruction on a display of the first participant.

Embodiments also include computer systems and computer program products for providing conversation based guided instructions during a video conference.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a block diagram of a system for providing conversation based guided instructions during a video conference in accordance with one or more embodiments of the present disclosure;

FIGS. 3A and 3B depict flowcharts of a method for providing conversation based guided instructions during a video conference in accordance with one or more embodiments of the present disclosure; and

FIG. 4 depicts a schematic diagram including a user interface having conversation based guided instructions during a video conference in accordance with one or more embodiments of the present disclosure.

### DETAILED DESCRIPTION

As discussed above, as the number of different video conferencing systems and the use of these systems has increased, a large amount of time during video conference is spent teaching participants how to use the various functions of any specific system. As a result, valuable time in the scheduled meetings is lost while one participant explains to another participant how to use any specific system.

Exemplary embodiments include methods, systems, and computer program products for providing conversation based guided instructions during a video conference. In exemplary embodiments, during a video conference including a first participant and a second participant, the audio and video of the participants are monitored to determine when one of the participants requires assistance in performing a task on an application on the device that they are using to conduct the video conference. In exemplary embodiments, the determination that one of the participants requires assistance in performing a task is based on determining that the participant appears to be confused. The method also includes determining that another one of the participants is providing instructions to the confused participant on how to complete the task. Based on determining that a participant is providing instructions, the video conference system obtains the instructions provided and converts the instructions into text, which is then displayed on a display screen of the confused participant.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as providing conversation based guided instructions during a video conference 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

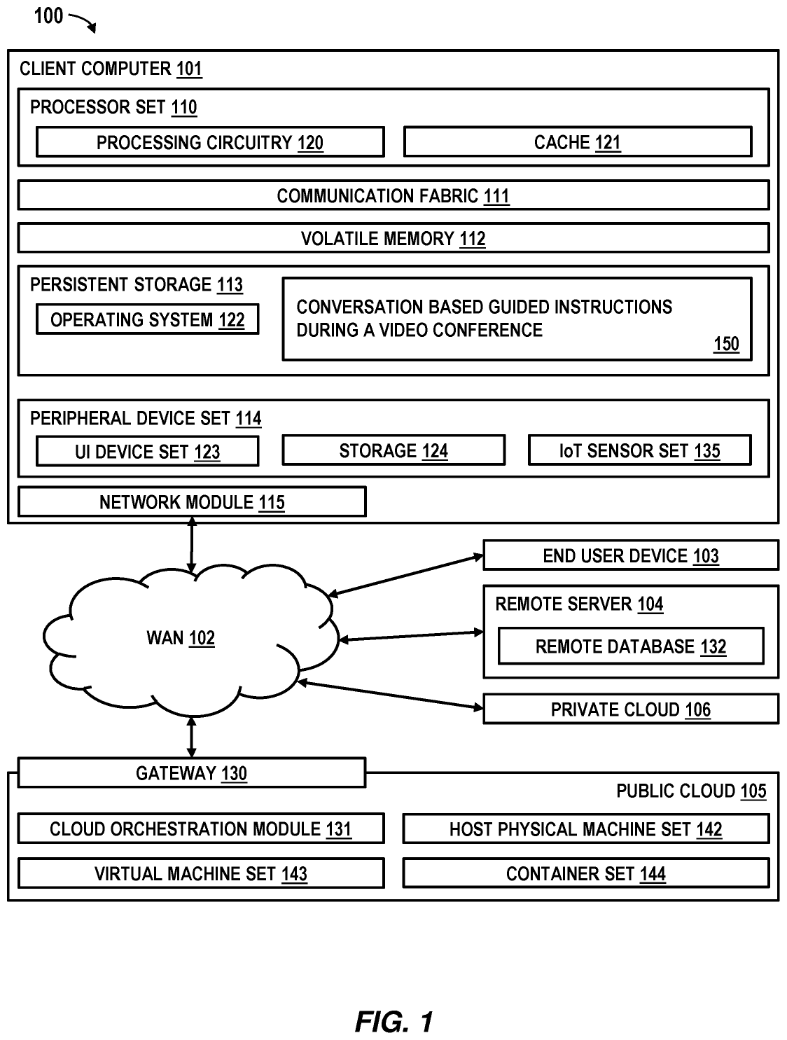

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 132, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

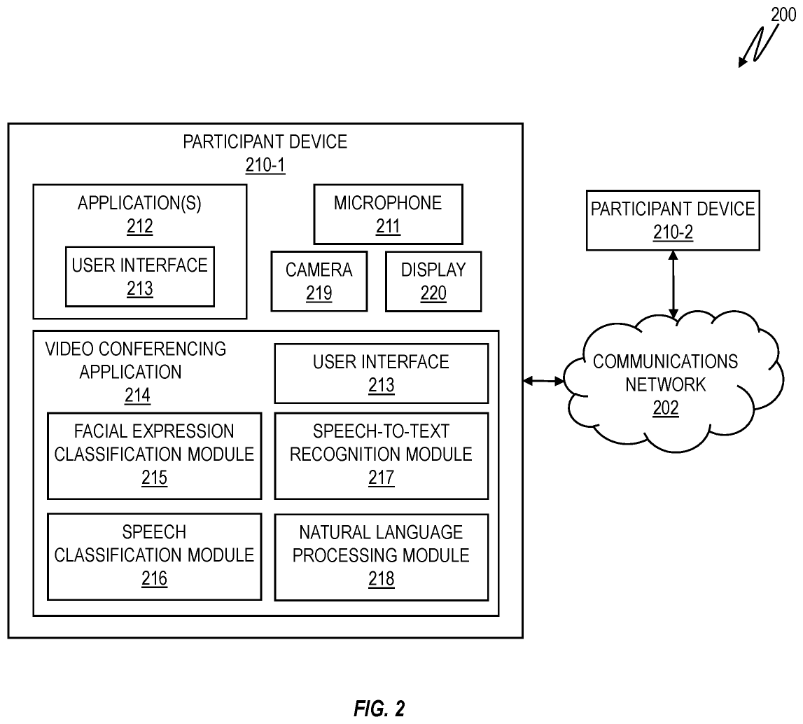

Referring now to FIG. 2, a block diagram of a system 200 for providing conversation based guided instructions during a video conference in accordance with one or more embodiments of the present disclosure is shown. As illustrated, the system 200 includes at least two participant devices 210-1 and 210-2, referred to collectively as participant devices 210. In exemplary embodiments, each participant device 210 is embodied in a computer 101, such as the one shown in FIG. 1. The participant devices 210 are each connected to a communications network 202 and communicate with one another via the communications network 202. The communications network 202 may include one or more public and private communications networks, such the Internet.

In exemplary embodiments, each participant device 210 includes a microphone 211 configured to capture a speech of a participant, a camera 219 configured to capture a video of a participant, and a display 220. Each participant device also includes one or more applications 212 that each includes a user interface 213 that can be displayed on the display 220 of the participant device 210. The applications 212 can include word processing application, presentation creation applications, web browsing application, and the like.

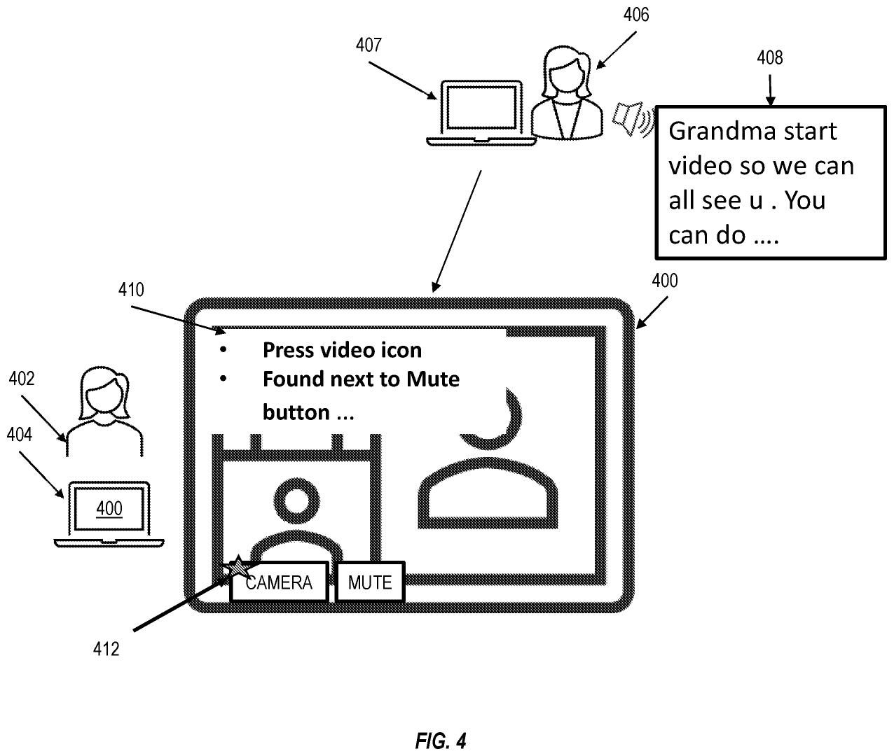

In exemplary embodiments, each participant device 210 also includes a video conferencing application 214 that is used to facilitate a video conference between various participant devices 210. The video conferencing application 214 includes a user interface 213, such as the user interface 400 shown in FIG. 4, that is displayed on the display 220 of the participant device 210. In addition, the video conferencing application 214 includes one or more of a facial expression classification module 215, a speech classification module 216, a speech-to-text recognition module 217, and a natural language processing module 218. In exemplary embodiments, these modules are used to analyze the video and speech of the participants during a video conference and to make determinations regarding a state of each of the participants.

In one embodiment, the facial expression classification module 215 is a trained machine learning model that is configured to analyze facial images or videos and determine the emotion or facial expression displayed by the subject. In one embodiment, the facial expression classification module 215 includes ResNet, which is a Convolutional Neural Networks (CNN) architecture that has been used for various computer vision tasks, including facial expression classification. In another embodiment, the facial expression classification module 215 includes Facial Expression Recognition Inference System (FERIS), which is a real-time facial expression recognition system that combines feature extraction techniques and SVM classifiers. In another embodiment, the facial expression classification module 215 includes EmoReact, which is a deep learning-based facial expression recognition model that uses CNNs and Long Short-Term Memory (LSTM) networks to capture temporal dependencies in facial expression sequences. In exemplary embodiments, the facial expression classification module 215 is configured to continuously monitor the facial images of the participants of a video conference and to continually output an emotion displayed by the participants. The emotion can include one of the following: happy; sad; angry; surprised; confused; neutral; disgusted; interested; helpful; relieved; and fearful.

In one embodiment, the speech classification module 216 is configured to analyze spoken language of the participants in a video conference and categorize it into different classes or categories based on certain characteristics or features. In one embodiment, the speech classification module 216 is configured to analyze spoken language of the participants in a video conference to determine and classify the emotional state of the speaker. The speech classification module 216 can categorize speech as being one of the following emotions: happy; sad; angry; surprised; confused; neutral; disgusted; interested; helpful; relieved; and fearful. In one embodiment, the speech classification module 216 includes Open Vokaturi, which is an open-source library for real-time emotion recognition from speech. Open Vokaturi uses a pre-trained model to analyze the emotional content in the speech signal and provides information about the underlying emotions expressed by the speaker. In another embodiment, the speech classification module 216 includes the Watson Natural Language Understanding developed by IBM.

In one embodiment, the speech-to-text recognition module 217, also known as Automatic Speech Recognition (ASR) system, is configured to convert the spoken language of the participants in a video conference into written text. The speech-to-text recognition module 217 takes in audio of the video conference and produces a corresponding textual representation as output. In one embodiment, the speech-to-text recognition module 217 includes Kaldi, which is an open-source toolkit for speech recognition that is widely used due to its flexibility, modularity, and support for various machine learning techniques.

In one embodiment, the natural language processing module 218 is configured to analyze the written text created by the speech-to-text recognition module 217 and to responsively generate instruction text that is displayed to a participant of the video conference. For example, the natural language processing module 218 may analyze the written text created by the speech-to-text recognition module 217 and extract a set of instructions from the written text. In addition, the natural language processing module 218 may be configured to format the extracted instructions into a bullet point list that each includes a single instruction. In exemplary embodiments, the natural language processing module 218 may also be configured to perform optical character recognition (OCR) of the user interface 213 of applications that are using the display 220.

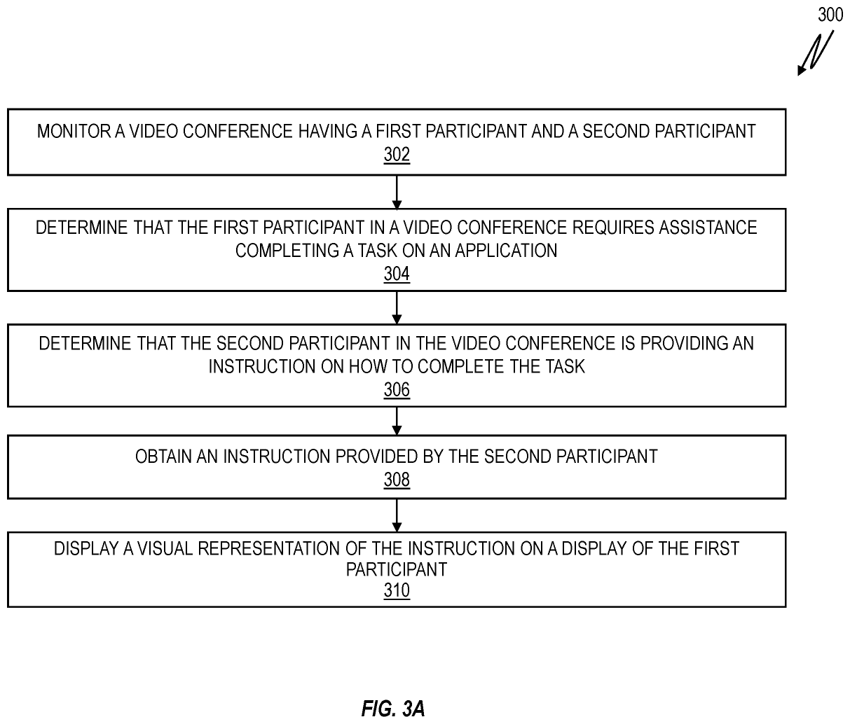

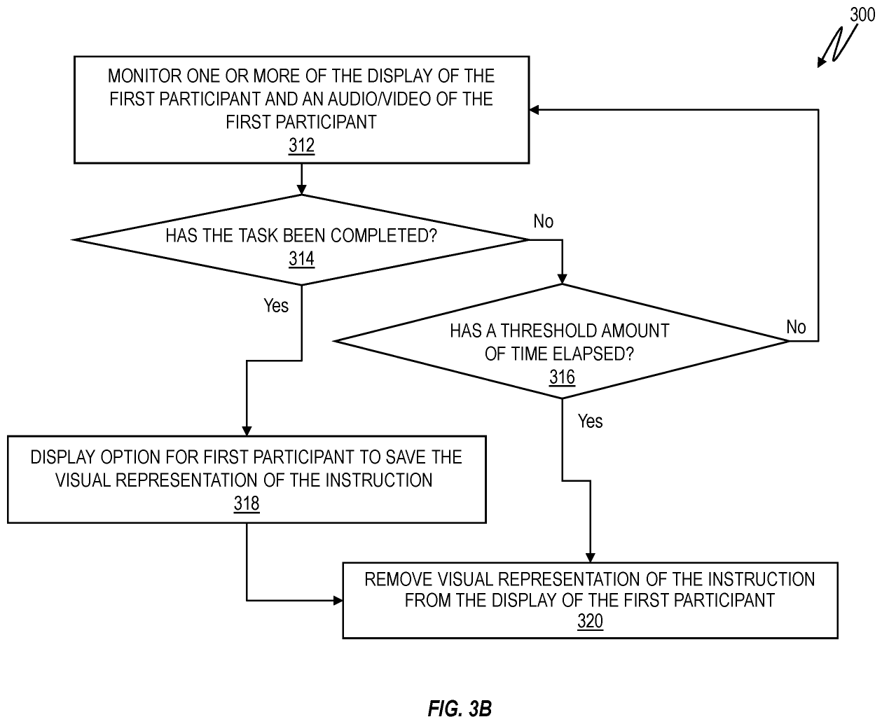

Referring now to FIGS. 3A and 3B, flowcharts of a method 300 for providing conversation based guided instructions during a video conference in accordance with one or more embodiments of the present disclosure is shown. In one embodiment, the method 300 is performed by a video conferencing application 214 such as the one shown in FIG. 2. At block 302, the method 300 includes monitoring a video conference that includes a first participant and a second participant. In exemplary embodiments, one or more of a video conferencing application disposed on processing system of the first participant and a video conferencing application disposed on processing system of the second participant are configured to monitor the video conference between the first participant and the second participant.

At block 304, the method 300 includes determining that a first participant in the video conference requires assistance completing a task on an application. In one embodiment, the application is the video conferencing application being used for the video conference. In another embodiment, the application is another application being used by the first participant. In exemplary embodiments, various methods may be used to determine that the first participant in the video conference requires assistance completing a task on an application.

In one embodiment, determining that the first participant requires assistance completing the task includes identifying that the first participant is confused by performing facial expression classification on a video of the first participant. For example, a facial expression classification module can be used to analyze the video of the first participant during the video conference and identify that the user is confused.

In another embodiment, determining that the first participant requires assistance completing the task includes identifying that the first participant is confused by performing speech classification of a speech of the first participant. For example, a speech classification module can be used to analyze the speech of the first participant during the video conference and identify that the user is confused. In one example, the speech classification module may determine that the first participant is confused by detecting the first participant asking questions such as “How do I . . . ”, “Where is the . . . ”, or the like.

In yet another embodiment, determining that the first participant requires assistance completing a task includes determining that the first participant is searching a user interface of the application by analyzing the movement of a mouse of the first participant. For example, the movement of a mouse of the user can be tracked via the display 220, and based on the movement of the mouse, it can be determined that the user is exploring or searching the user interface of the application. This determination can be based on analyzing a pattern of movement of the mouse and comparing it to a set of known movements of users trying to find a desired user interface element on the display.

In exemplary embodiments, determining that the first participant requires assistance completing the task can be based on a combination of one or more of the above methods. For example, by analyzing both the movement of the mouse of the first participant and the speech/video of the first participant.

Once it is determined that the first participant requires assistance completing a task on an application, the method 300 proceeds to block 306. At block 306, the method 300 includes determining a second participant in the video conference is providing an instruction on how to complete the task. In exemplary embodiments, various methods may be used to determine that the second participant in the video conference is providing an instruction on how to complete the task on the application.

In one embodiment, determining that the second participant in the video conference is providing the instruction on how to complete the task comprises performing one or more of facial expression classification on a video of the second participant and speech classification on a speech of the second participant to determine that the second participant is one of helpful and interested. In another embodiment, determining that the second participant in the video conference is providing the instruction on how to complete the task includes performing speech-to-text recognition on a speech of the second participant and performing natural language processing on the speech of the second participant to identify a set of instructions that are being provided by the second participant.

Next, as shown at block 308, the method 300 includes obtaining the instructions provided by the second participant. In one embodiment, obtaining the instructions provided by the second participant includes performing a speech-to-text recognition on a speech of the second participant to generate a written text of the speech of the second participant. On the written text of the speech of the second participant is generated, the instructions are obtained from the written text by performing natural language processing on the written text to identify and extract one or more steps of the instructions. In one embodiment, a natural language processing module is configured to receive the written text as input and to provide a set of bullet point instructions steps that were extracted from the written text.

In exemplary embodiments, the output of the natural language processing module is compared to a text displayed on the user interface of the first participant to identify one or more user interface elements on the display of the first participant that correspond to the user interface elements referenced in the instruction steps. As a result, it is determined whether the instructions include an identified user interface element of the application being displayed on the display of the first participant.

At block 310, the method 300 includes displaying a visual representation of the instruction on a display of the first participant. In one embodiment, the visual representation of the instruction is displayed as a pop-up window on the display of the first participant. In one embodiment, the visual representation of the instructions includes the set of bullet point instructions steps that were extracted from the written text.

In embodiments where the instructions include an identified user interface element of the application being displayed on the display of the first participant, the method also includes displaying an indicator on the display of the first participant adjacent to the identified user interface element. For example, if the set of instructions includes “Click on the Microphone Icon” and the user interface has an icon that includes a label of microphone, the method may display an arrow, star, or another indicator next to the identified icon on the display to draw the attention of the first participant to the icon.

Continuing with reference to FIG. 3B, the method 300 also includes monitoring one or more of the display of the first participant and an audio/video of the first participant, as shown at block 312. Next, as shown at decision block 314, the method 300 includes determining whether the task has been completed. In exemplary embodiments, the determination that the task has been completed is based on the facial expression classification module and/or the speech classification module indicating that the first participant is one of happy and relieved. In another embodiment, the determination that the task has been completed is based on an analysis of actions that the first participant performed on the user interface on the display. For example, if the instructions included “Click on the Microphone Icon” it can be determined whether the first participant performed the task of clicking on an identified microphone icon.

Based on a determination that the task has been completed, the method 300 proceeds to block 318, and an option for first participant to save the visual representation of the instruction is displayed. In exemplary embodiments, the first participant is able to save the displayed text, and optionally screen shots of the user interface, for later reference when the user is again attempting to perform the task.

Based on a determination that the task has not been completed, the method 300 proceeds to decision block 316 and it is determined whether a threshold amount of time has elapsed since the instructions were displayed. In one example, the instructions may only be displayed for two minutes. In exemplary embodiments, the length of the threshold amount of time can be set by each participant of the video conference.

Based on a determination that the threshold amount of time has elapsed since the instructions were displayed, the method 300 proceeds to block 320, and the visual representation of the instruction is displayed on the user interface is removed. Based on a determination that the threshold amount of time has not elapsed since the instructions were displayed, the method 300 returns to block 312.

Referring now to FIG. 4, a schematic diagram including a user interface 400 having conversation based guided instructions during a video conference in accordance with one or more embodiments of the present disclosure is shown. In one embodiment, a first participant 402 is using a first device 404 to participate in a video conference with a second participant 406, who is using a second device 407. The user interface 400 show is displayed on the display of the first device 404. As illustrated, the second participant 406 is providing instructions 408 to the first participant on how to activate her camera. In exemplary embodiments, the user interface 400 includes a pop-up window 410 that includes a bullet point list of instructions that are obtained from the instructions 408 provided by the first participant 402. In addition, the user interface 400 includes an indicator 412, illustrated as a star, that is disposed adjacent to the user interface element referenced in the pop-up window.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of #8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for providing conversation based guided instructions during a video conference, the method comprising:
determining a first participant in the video conference requires assistance completing a task on an application;
determining a second participant in the video conference is providing an instruction on how to complete the task;
obtaining the instruction provided by the second participant; and
displaying a visual representation of the instruction on a display of the first participant.

2. The method of claim 1, wherein the instruction includes an identified user interface element of the application being displayed on the display of the first participant.

3. The method of claim 2, further comprising displaying an indicator on the display of the first participant adjacent to the identified user interface element.

4. The method of claim 1, wherein determining that the first participant requires assistance completing the task comprises identifying that the first participant is confused by performing facial expression classification on a video of the first participant.

5. The method of claim 1, wherein determining that the first participant requires assistance completing the task comprises identifying that the first participant is confused by performing speech classification of a speech of the first participant.

6. The method of claim 1, wherein determining that the first participant requires assistance completing the task comprises determining that the first participant is searching a user interface of the application by analyzing a movement of a mouse of the first participant.

7. The method of claim 1, wherein determining that the second participant in the video conference is providing the instruction on how to complete the task comprises performing speech-to-text recognition of a speech of the second participant and natural language processing on the speech of the second participant.

8. The method of claim 1, wherein obtaining the instruction provided by the second participant comprises performing a speech-to-text recognition on a speech of the second participant.

9. The method of claim 1, wherein the application is a video conference application being used for the video conference.

10. The method of claim 1, wherein the visual representation of the instruction is displayed as a pop-up window on the display of the first participant.

11. The method of claim 1, further comprising:
determining that the first participant has completed the task;
displaying an option for the first participant to save the textual representation of the instruction; and
removing the visual representation of the instruction from the display of the first participant.

12. A computing system having a memory having computer readable instructions and one or more processors for executing the computer readable instructions, the computer readable instructions controlling the one or more processors to perform operations comprising:
determining a first participant in the video conference requires assistance completing a task on an application;
determining a second participant in the video conference is providing an instruction on how to complete the task;
obtaining the instruction provided by the second participant; and
displaying a visual representation of the instruction on a display of the first participant.

13. The computing system of claim 12, wherein the instruction includes an identified user interface element of the application being displayed on the display of the first participant.

14. The computing system of claim 13, wherein the operations further comprise displaying an indicator on the display of the first participant adjacent to the identified user interface element.

15. The computing system of claim 12, wherein determining that the first participant requires assistance completing the task comprises identifying that the first participant is confused by performing facial expression classification on a video of the first participant.

16. The computing system of claim 12, wherein determining that the first participant requires assistance completing the task comprises identifying that the first participant is confused by performing speech classification of a speech of the first participant.

17. The computing system of claim 12, wherein determining that the first participant requires assistance completing the task comprises determining that the first participant is searching a user interface of the application by analyzing a movement of a mouse of the first participant.

18. The computing system of claim 12, wherein determining that the second participant in the video conference is providing the instruction on how to complete the task comprises performing speech-to-text recognition of a speech of the second participant and natural language processing on the speech of the second participant.

19. The computing system of claim 12, wherein obtaining the instruction provided by the second participant comprises performing a speech-to-text recognition on a speech of the second participant.

20. A computer program product comprising a computer readable storage medium having program instructions embodied therewith, the program instructions executable by a processor to cause the processor to perform operations comprising:
determining a first participant in the video conference requires assistance completing a task on an application;
determining a second participant in the video conference is providing an instruction on how to complete the task;
obtaining the instruction provided by the second participant; and
displaying a visual representation of the instruction on a display of the first participant.
